(19) United States
(12) Patent Application Publication
(10) Pub. No.: US 2005/0262020 A1
(43) Pub. Date: Nov. 24, 2005

(54) Method and system for subscriber spending control in a communications system

(76) Inventor: Stefan Karlsson, Karlskrona (SE)

Correspondence Address: NIXON & VANDERHYE, PC, 901 NORTH GLEBE ROAD, 11TH FLOOR, ARLINGTON, VA, 22203, US

(21) Appl. No.: 10/512,835

(22) PCT Filed: Apr. 30, 2003
(86) PCT No.: PCT/SE03/00714

§ 371 Date: Jun. 1, 2005

(30) Foreign Application Priority Data
Apr. 30, 2002 (SE) 0201329-0

(51) Int. Cl. G06F 17/60

(52) U.S. Cl. 705/41

(57) ABSTRACT

A data processing system and a method for providing spending control to a post-paid user in a communications system comprising computer processing means (11) for processing data, and storage means connected to said computer processing means for storing data on a storage medium. The computer processing means is configured to in response to a request for service(s) payable by said user invoke a spending control function (16) which is arranged to create a spending control account, establish an association between the user and the spending control account for temporary spending control, initialize a spending control parameter for the spending control account with a spending control limit, request one or more service(s) to be delivered to the user, monitor the cost of the one or more service(s) and indicate when the cost amounts to the spending control limit

### FIELD OF THE INVENTION

The present invention relates to a method and system for use in an electronic communications network providing services for stations connected to the network, and more particularly to a method and system for subscriber spending control in a communications system.

### DESCRIPTION OF THE PRIOR ART

Modern communication systems offers a great variety of different techniques such as GSM, UMTS, cdma2000, TDMA and IS95 for mobile networks, ISDN, PSTN and ADSL for fixed networks and WLAN for wireless data communication access Common for all these networks is that they have evolved to be used as access networks towards the global communication network using the TCP/IP protocol suite commonly known as the Internet.

The mobile networks are now in the process of converging with the Internet, forming new service making use of the intrinsic characteristics of the mobile networks. Examples of such characteristics are user location and the connection between the user and the terminal used for access providing personalisation and ensuring for example authentication.

In this growing and converging global network new or evolved user services are emerging forming what is commonly known as the Mobile Internet Examples are different bearer services like GPRS, voice and circuit switched data and user services like location based services, information services, games and payment services.

Billing for the use of such networks and their associated services are made by means of different payment mechanisms. Telephony charging has traditionally been based on duration of the phone call and whether it is local, long distance or international. People use the phone and pay their bills later. The functionality of the post-paid system described above functioned efficiently for voice calls on land lines, but it does not work well for the Mobile Internet where the charging is much more complex. Post-paid services may also exhibit a high deposit barrier and the risk of bad debt for the operator.

Another payment mechanism with which these disadvantages may be removed is prepaid. With this mechanism, benefits for the operator are earlier revenue and decreased cost for administration, credit checks, and printing of invoices. Prepaid service is a telecommunication service that requires the customer to pay in advance before a call is made or a chargeable event is rendered, for example by buying a so called cash or scratch card.

During the past few years the prepaid services market has grown exponentially all over the world.

From the customer's viewpoint, prepaid services provide immediate service without the need to sign a long-term contract of commitment and it allows better control of spending. Thus, implicit spending control is provided since the customer can never spend more than what is already paid for in advance or use more funds than the allowed credit limit.

In the prior art, for example in the article Mobile Prepaid Phone Service in IEEE Personal Communications June 2000 Volume 7 Issue 3, four approaches is proposed to provide mobile prepaid services. These approaches are hand set based, wireless intelligent network, service node and hot billing.

In the handset-based approach, the mobile station (MS) performs credit deduction during the call and checks whether the credit limit have been reached. In this approach the credit is stored on the MS, either at a Subscriber Identity Module (SIM) card as in the GSM system, or in the MS memory itself.

The Service Node (SN) is the most commonly used. In the SN approach, a call is initiated by the subscriber indicating the call by dialling the called party's telephone number. The MSC identifies that the caller is a prepaid customer and sets up a connection towards the SN. The SN authorizes the call request by consulting a prepaid billing platform and if the call request is granted the SN sets up a trunk back to the MSC, and the trunk is eventually connected to the called party. After that, the SN starts credit decrementing.

In the hot billing approach, Call Detail Records (CDRs) are used to process prepaid usage. The information in a CDR includes for example type of service, date/time of usage, user identification, destination of the call and location information. These records are generated when the call is completed and are transported from the MSC to the prepaid service center. The customer's prepaid balance is then decremented according to the CDRs.

Another approach is the Intelligent Network solution (IN), for example the PrePaid Services (PPS) system developed by the applicant. IN is a network architecture connected to the basic network (for instance a fixed or mobile network), enabling faster, easier, and more flexible service implementation and service control. This is effected by transferring the service control from the switching centre to a separate functional IN unit. Thus, the service becomes independent of the basic network operation, and the basic network structure and software need not be changed when services are altered or added. Examples of such services are premium rate calls, mobile virtual private network, personal number and prepaid services. In the IN prepaid approach the customer initiates a call by dialling the called party's telephone number. The MSC encounters the IN call set up trigger and suspends the call while contacting the Prepaid Service Control Point (SCP). By querying its associated prepaid database the SCP determines if the call may be allowed or not and if allowed the SCP instructs the MSC to set up the call. The MSC surveys the call according to instructions from the SCP. When the call is ended, either due to depleted credit or call ended by the customer, the MSC informs the SCP about the ended call, the SCP rates the completed call and the customer's account balance is updated accordingly.

The notion of real-time charging is used as when the charging process is performed as part of rendering a service. Real-time charging means that the serving element halts the execution of the service and checks automatically if consumers have credit or reserves and only allows the call to go through if appropriate. On-line charging is the term used for a bi-directional, high capacity communication between the network/serving element and a charging function allowing for the transfer of charging information in such a way that the charging process does not violate the above described real time charging notion. Thus, on-line charging is like using a credit card at the supermarket, and consumers can pay later. They don't need to have a pre-payment card, just a healthy credit limit.

Real-time charging used for prepaid accounts ensures that the bills get paid. Users like this because they can't overdraw their credit or deposited balance. Real-time charging accounts have credit that the network can check and users can't make a call or access a service if they have overdrawn their credit limit. If the credit is good, the connection proceeds independently of if the user have paid in advance or, just like an ordinary credit card, pays later.

Many players now want to take part in the Mobile Internet charging. Examples are portals which want the user to pay via an e-commerce solution, banks may charge via its own credit card or credit card companies themselves may bill customers. One of the simplest way to pay is based on the user's phone number. This means that the telephone bill turns up as usual, or that the prepaid account is debited.

Content charging is one important aspect which the network must recognize the value of so that it can charge accordingly, and not only charge for megabytes transferred.

Post-paid will remain an important payment mechanism but prepaid is vital for the Mobile Internet because it means that operators or service providers have credit control. A user can for example spend a lot of money in a very short time on games and multimedia services. With prepaid based on real-time charging the user's account balance is checked and the cost of a service is pre-reserved on the account before delivery thereby minimizing the risk of bad debt. Therefore it is likely that the future will be a mixture of prepaid subscribers and post-paid subscribers.

In the past, payment mechanisms where primarily focused on the network operator or service provider being able to get paid for its services. When users spend increasingly higher amounts on communications services the issue of spending control is of equal importance but to get real-time spending control a subscriber needs to have a real-time charging subscription.

Technically, non-real-time or off-line charging which relies on batch processing of Call Detail Records (CDRs) is used for post-paid, and real-time or on-line charging is used for at least IN based prepaid.

If a post-paid subscriber does not want to change subscription type but want to have access to a spending-limitation service, e.g. directed towards the service provider or a content provider when playing on-line games, there are not any service or feature available to achieve this.

The same problem occurs when a subscriber during a session wants to purchase and consume several items from the same merchant whose service do not support a shopping basket for the complete session. Examples are when the goods are made for immediate consumption, e.g. streaming of a music section. In this case the user usually has to go through the purchase process for each item and will not get spending control for the session as a whole. Also for a prepaid subscriber, real time spending control is as described earlier only implicitly provided even though the charging is real time. The notion of implicit spending control is used since the more money is deposited on the account, the more can be accidentally spend, thus eroding the control given.

If post-paid subscribers want to get spending control their subscription schemes can be migrated to real-time prepaid subscriptions. A major disadvantage with this is permanent allocation of system resources with respect to both memory utilisation and processing and signalling capabilities thereby seriously jeopardizing the fulfilment of the notion of on-line charging.

### SUMMARY OF THE INVENTION

It is an object of the present invention to provide an improved method and system for providing real time spending control to a user in a communication system.

This object is achieved by a data processing system for providing spending control to a user in a communications system comprising computer processing means for processing data, and storage means connected to the computer processing means for storing data on a storage medium, wherein the computer processing means is configured to in response to a request for service(e) payable by the user invoke a spending control function which is arranged to establish an association between the user and a spending control account for temporary spending control, initialise a spending control parameter for the spending control account with a spending control limit, request one or more service(a) to be delivered to the user, monitor the cost of the one or more service(s) and indicate when the cost amounts to the spending control limit.

A more specific object of the invention is to provide a system which cuts off the call, or service delivery, when the cost amounts to a limit.

This is achieved by the data processing system according to the invention, wherein the computer processing means is further arranged to cut off the call, or service delivery, when the cost amounts to the spending control limit.

Another object of the present invention is to provide a method for providing real time spending control to a user in a communication system.

This is achieved by a method of providing spending control to a user in a communications system wherein a request for service(s) payable by the user invokes a spending control function which establishes an association between the user and a spending control account for temporary spending control, initializes a spending control parameter for the spending control account with a spending control limit requests the service(s) to be delivered to the user, monitors the cost of the service(s) and indicates when the cost amounts to the spending control limit, and when the service(s) has finished removes the association between the user and the spending control account.

Yet another object of the present invention is to provide a method for removing redundant charging data for spending controlled service(s) in a communication system.

This is achieved by a method for removing redundant charging data for spending controlled service (s) in a communication system wherein a service node sends first charging data for the service(s) to a billing node, an account and rating function generates second charging data for temporary spending control of the service(s) and indicates that the second data overrides the first data, sends said second charging data to said billing node, and the billing node removes the first charging data corresponding to the indicated second data.

An advantage with the present invention is obtained and improved real-time spending control for users, with the flexibility and system capacity utilisation of post paid and off-line charging preserved.

A further advantage with the present invention is to let the operator be able to provide real-time spending control without having the subscriber changing his subscription type to a pre-pay or real-time charging subscription.

### BRIEF DESCRIPTION OF THE DRAWINGS

In order to explain the invention and the advantages and features thereof in more detail the preferred embodiments will be described below, references being made to the accompanying drawings, in which

FIG. 1 is a schematic view of a part of a cellular mobile telephone network, comprising a system for subscriber spending control according to the invention

FIG. 2 is a schematical view of an intelligent network signalling implementation of the network in FIG. 1,

FIG. 3 is a schematical view of a network implementation for accessing a spending control function according to the invention.

FIG. 4 is a flow chart of a method for spending control at a fixed limit according to one embodiment of the invention.

FIG. 5 is a schematical view of a system for handling redundant CDRs according to one aspect of the invention.

FIG. 6 is a flowchart describing a method for handling redundant CDRs according to one aspect of the invention.

FIGS. 7-9 are flow charts of a method for spending control at a configurable and extensible limit.

FIG. 10 is a schematical view of a network for spending control wherein the service to be spending controlled resides outside the network in FIG. 1.

FIG. 11 is a process diagram illustrating different co-operating processes providing spending control according to one embodiment of the invention.

Figures are, where applicable, described using the Specification and Description Language (SDL) according to the ITU-T standard Z.100.

### DETAILED DESCRIPTION OF THE INVENTION

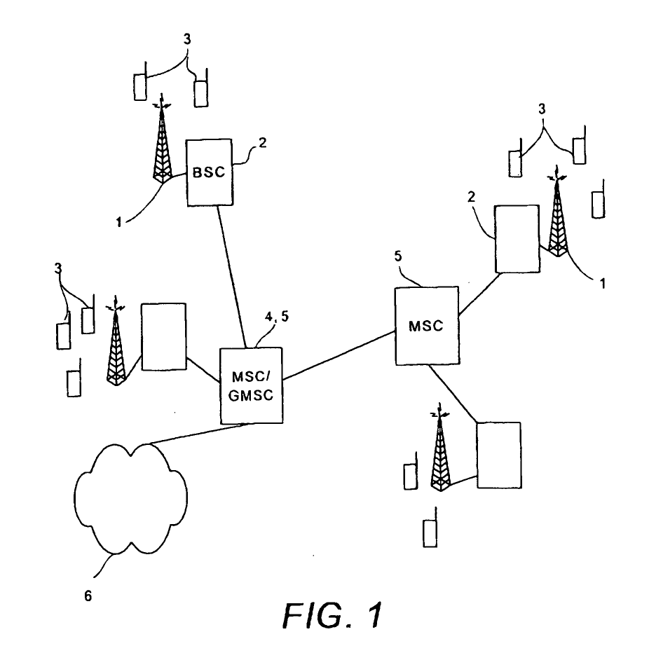

Referring to FIG. 1, there is shown an example of a communications network such as a cellular mobile telephone network or PLMN (public land mobile network) including a service providing network, such as an intelligent network (IN), for facilitating spending controlled service delivery to subscribers and users connected to the network according to the invention, wherein a service is any chargeable event including time-based, volume-based, value-based, transaction based events or any combination thereof.

Cellular telephone service, such as GSM, involves the subdivision of a service area into a number of smaller cells. Each cell requires a base transceiver station (BTS) 1 and is connected to a base station controller (BSC) 2, as shown in FIG. 1. The base station 1 handles the radio connection towards the mobile station (MS) 3 while the base station controller 2 performs the tracking of mobile stations 3 as well as supervision of one or more base stations 1. A mobile services switching centre (MSC) 4 performs switching of user data and provides specific data, about individual mobile phones 3 while a gateway mobile services switching centre (GMSC) 5 also operates as an interface towards other networks such as other PLMNs, ISDN or the public switched telephone network (PSTN) 6.

The (G)MSC 4 and 5 comprises a data processing system, including a computer processor for processing data, and storage means connected to the computer processor for storing data on a storage medium.

Additionally, the GSM network has a signalling network, which performs message switching between network elements. In one embodiment of the invention, a specific type of signalling protocol, signalling system no. 7 (SS7), is used for the exchange of information messages and carries many types of information elements. However, SS7 is only an example and the signalling protocol can be another protocol such as the Internet Protocol (IP).

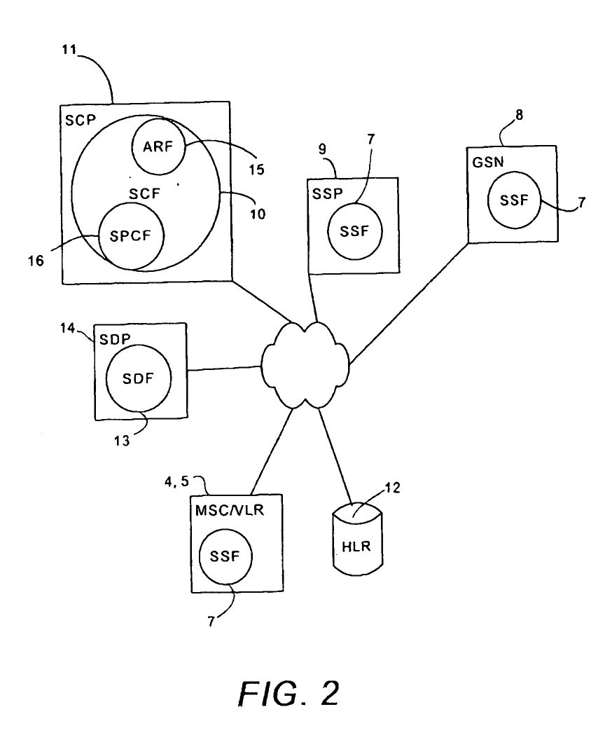

Referring to FIG. 2, there is shown a schematical view of an intelligent network implementation that can be connected to the network in FIG. 1 including a service switching function (SSF) 7 located in the (G)MSC 4,5, in the Gateway or Serving GPRS Support Node (GSN) 8 or as a standalone service switching function (SSP) 9. The (G)MSC 4, 5 and GSN B detects events indicating a service requiring IN and after this triggering, the SSF 7 is invoked and suspends service processing and starts a series of transactions with a service control function (SCF) 10 located at a service control point (SCP) 11. The SCP 11 is a real-time data processing system that, based on information from the SSF 7, performs subscriber or application specific service logic, controlling the service flow, call set-up and call flow.

A home location register (HLR) 12 stores the identity and user data of all the subscribers belonging to the area of the related (G)MSC 4,5. The HLR 12 provides the (G)MSC 4,5 with the necessary subscriber data when a call is coming from a public switched network (PSTN) 6, an ISDN network, Internet etc. A visitors location register (VLR) contains relevant data of all mobiles currently located in a serving (G)MSC 4,5. The VLR has to support the (G)MSC 4,5 during call establishment when a call is coming from a mobile telephone 3.

A service data function (SDF) 13 located in a service data point (SDP) 14 or in the SCP 11 (not shown in the figures) is a database containing service class data and tariff data. In this embodiment rating and charging analysis is handled by the SCP 11 while it could likewise be handled by the SDP 14.

Users may access and trigger a spending control function in a number of different ways. An accounting and rating function (ARF) 15 handles rating of services and charging of accounts for real-time charging, for example prepaid. A spending control function (SPCF) 16 is located at the SCP 11 and controls the costs incurred on a subscriber account located at the SDP 14. In this embodiment the spending control function is invoked as an intelligent network service.

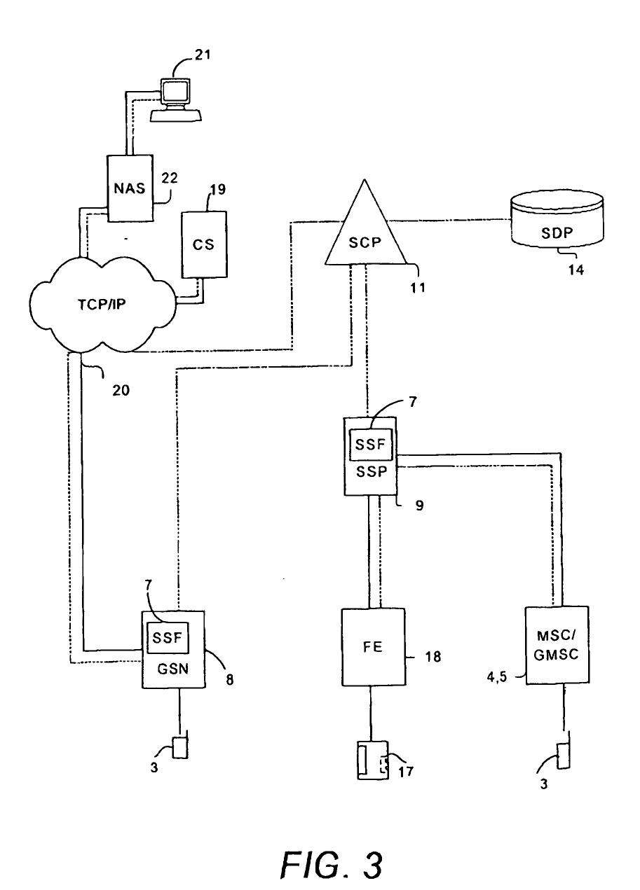

A user may access the spending control function via a number of access methods which is further described with reference to FIG. 3. If the spending function service is accessed via an MS 3 or a fixed telephone 17, the SPCF 16 is invoked by the SSP 9 connected to the (G)MSC 4,5 or the fixed exchange (FE) 1B. If the spending control function is accessed via an MS 3 with GPRS capabilities the GSN 8 will directly invoke the SPCF via its co-located SSF 7. If accessing a service at a content server (CS) 19 connected to the Internet 20 via a data terminal 21 through a network access server (NAS) 22, the data terminal 21 can directly access the SPCF 16 via a TCP/IP network 20 as the Internet.

The invention will now be described by its functional characteristics. In a one set of embodiments, the spending control function provides spending control for on-line sessions. On-line session control is used to support ordinary circuit switched calls and packet switched sessions. The packet switched service GPRS is horizontally separated from the service using GPRS as bearer. A session is here defined as a chargeable instance that is charged based on consumption, for example time or volume. Examples of sessions are a circuit switched call or a GPRS session. No distinction is made regarding whether the session is originating or terminating with respect to the charged party.

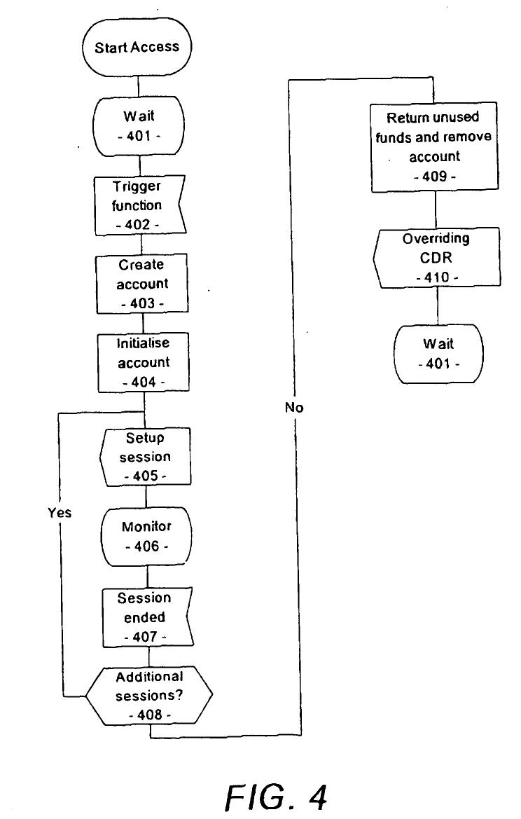

Referring to FIG. 4 in the drawings there is shown a flowchart illustrating a method for on-line spending control for one or more sessions within a fixed spending control limit according to a first embodiment of the invention. Before a mobile telephone user can make a phone call or use another service provided by the network he/she has to be a “subscriber”.

In step 401 the system is in a state waiting for the spending control function to be triggered. The user then triggers a spending controlled session by initiating a service request indicating that the service should be spending controlled in step 402. If the service is for example a circuit switched call triggering is done by that the user dials a specific prefix or uses a specific service number, the latter commonly known as office based triggering, to invoke the spending control function. This means that no permanent triggering data needs to be set on the subscription. The triggering may also be done as an ordinary IN service, that is, OICK/TICK parameters are set for the subscriber in the HLR. GPRS usage spending control is triggered by PDP context activation but can also be triggered on GPRS attach if all GPRS sessions are to be spending controlled. In another embodiment the user is permanently defined as a real-time charging user but has the possibility to activate/deactivate the real-time charging and spending control function by user interaction over for example intelligent peripherals using speech/DTMF, USSD, SMS, WAP.

The spending control function creates a temporary account in an account database of the charging control system in step 403, for example in the SDP 14. The temporary account is initialised with a predetermined amount of money (credit) in step 404. For a post paid subscriber the credit is linked to his/here subscription. Alternatively the money is transferred as an electronic payment. The payment can also be done from an electronic wallet in the mobile phone or from a smart card attached to the mobile phone, for example a terminal based prepaid account. An identification is done (user phone ID or login) to get access to the temporary spending limit control. The predetermined amount can also be predefined for all or specific services/subscribers and/or dependent on the service number dialled/PDP context activated, number series etc.

In step 405, the session is set up as an ordinary prepaid session according to the initial request. The session is monitored and charged on-line by the ARF 15 as with any ordinary pre-pay/real-time charging session in step 406. When the session is ended, the SPCF 16 is notified by the ARF 15 in step 407. This can occur due to the user stopping the session, for example by hanging up the call, or due to that the spending control account limit is reached.

It is determined in step 408 if additional services are to be done within the same spending control limit. If so, a new service is being set up in step 405 and again handled as an ordinary prepaid/real-time charging service but now with the remaining of the initial spending control limit as available funding for the service. In this embodiment follow-on calls is possible if the spending limit has not been exceeded which means that the control is never released and the end-user never disconnects, e.g. the user is prompted for a new number. For GPRS where the spending control is made on the GPRS session (several PDPs in one context) the spending control is retained also over the next PDP context.

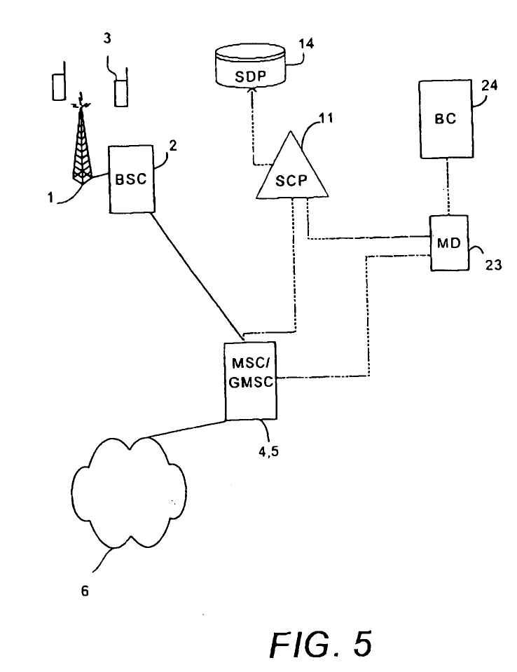

If funds were moved to the temporary account and where are funds left is determined in step 409. If so, the money remaining which has not been used is returned to its source and the temporary account is removed. In step 410 the final charge for the session is output in a CDR which is tagged to indicate that this CDR overrides other CDRs produced in the network. The deletion of redundant CDRs is done in a mediation device 23 or a billing system 24, see FIG. 5.

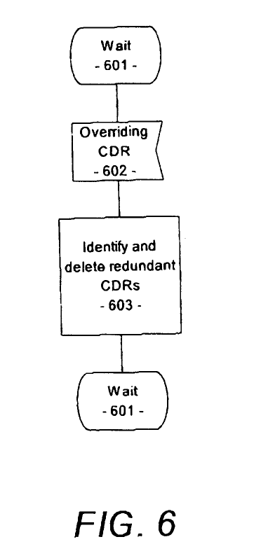

Referring now to FIG. 5 and FIG. 6 a schematical view of a system for handling redundant CDRs according to one aspect of the invention is shown, together with a flowchart describing the process of removing redundant CDRs. In this embodiment the service element delivering the user service, for example the (G)MSC 4,5 continues to create call detail records CDRs independently of the spending control function and these are sent to the mediation device (MD) 23 for processing and further delivery to the billing center (BC) 24. The ARF 15 in the SCP 11 also generates CDRs and sends these to the MD 23 but marks these to indicate that they override those created by the service element. The MD 23 processes the CDRs and locates the redundant CDRs as to avoid double debiting. In FIG. 6, the process for removing redundant CDRs is in a waiting state in step 601 awaiting an incoming CDR to process. In step 602 a CDR marked as overriding ordinary CDRs is received. Already received CDRs are scanned so that those including data relevant for the same event as the one received in step 602 are located and removed in step 603. When the redundant CDR(s) is removed the process again goes into the waiting state 601 waiting for new CDRs to process. The valid CDR is then processed by the billing system BC 24 and invoiced with the users telephone bill, if not an electronic wallet or similar was used for payment.

In an alternative embodiment, step 410 in FIG. 4 is done after each session to reduce delay.

In yet another alternative embodiment the cost calculated by the spending control function is only used for the spending control itself and not for the actual charging. If so, step 410 may be omitted.

In a second embodiment of the invention the user has the possibility to set the call limit at call set up. This limit can either be a final limit or the end user is prompted if the limit should be extended further when the limit is reached. If so a maximum accumulated usage may also be set. For GPRS it is also possible to use GPRS redirect, and direct to a specific Access Point Name (APN) that could perform the user interaction. This second embodiment will now be described with reference to FIG. 6-9.

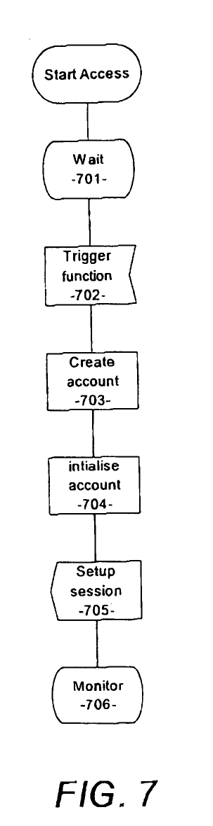

In step 701 in FIG. 7 the system is in a state waiting for the spending control function to be triggered. The user initiates a service in step 702, indicates that it should be spending controlled and possibly also enters or indicates a spending control limit. The spending control function creates a temporary account in the account database of the charging control system in step 703. The temporary account is initialized with a value in step 704, the value corresponding to the spending control limit entered by the user in step 704. The service is set up as an ordinary prepaid service in step 705 using the temporary account. In step 706 the service is monitored and charged on-line by the account and rating function ARF as with any ordinary pre-pay service.

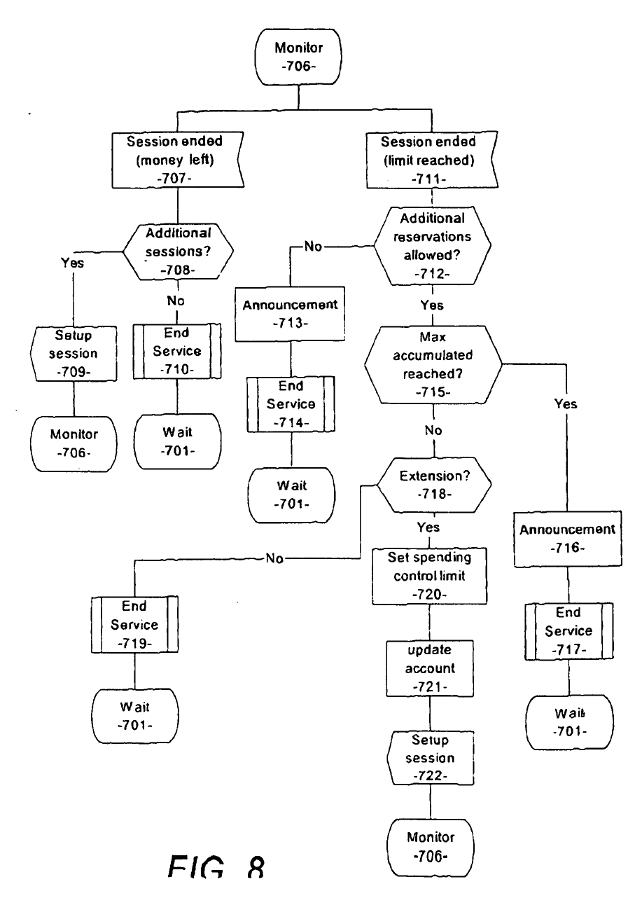

With reference to FIG. 8, if the service is terminated and there are still funds an the temporary account the account and rating function will signal this to the spending control function in step 707. The user may then in step 708 be prompted by for example an interactive voice response unit if he wants to continue the session with another service. If so, a new service may be set up or delivered to the user in step 709 and the spending control function returns to its monitoring state 706. If the user in step 708 determines not to use any other service but to stop the session, this is initiated in step 710.

In one embodiment the ARF suspends the service when the spending control limit is reached. The user is then prompted in step 708 if the limit should be extended and if so, new funds are added to the spending control account and the ARF is informed so that the service can continue until the new limit is reached.

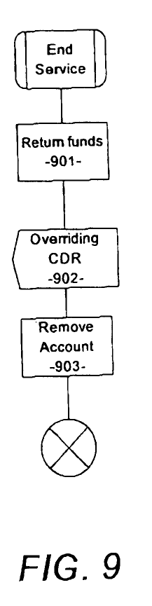

The further steps executed by the subroutine End Service is further described in FIG. 9. In step 901 unused funds, if not credited, are returned to the source from which the money was transferred. CDRs are produced for billing in step 902 and marked as overriding CDRs produced by the network, as has been described earlier in conjunction with FIG. 5 and FIG. 6. If a temporary account was created in step 703, it is removed. If an account from an account pool was used the connection between the user and the account is removed and the account made available in the pool again. If an account permanently linked to the user was used, it is deactivated. After step 903, referring back to FIG. 8, when the service is finalized it goes into a waiting state 701, waiting for a new session to be triggered.

Continuing with reference to FIG. 8, if the service is terminated due to the spending control limit being reached the spending control function SPCF is notified by the account and rating function ARF in step 711. In step 712 it is checked if additional reservations are allowed and if not, the user is notified in step 713 and the service is finalized in step 714. After the finalising steps 901-903 in FIG. 9, the spending control function goes into its waiting state 701. If further reservations are allowed in step 112 the spending control functions checks in step 715 whether a maximum accumulated amount have been reached. If so the user is notified in step 716 and the service is finalised in step 717 after which the function goes into its waiting state 701.

If the maximum accumulated value was not reached the user is prompted in step 718 whether an extension of the spending control limit is wanted. If not, the service is waiting state 701. If an extension is wanted the user is prompted for a new limit in step 720 and the amount is added to the temporary account in step 721. The session may now continue and a new service is allowed to be set up in step 722 after which the spending control function goes back into its monitoring state 706.

According to a third embodiment of the invention, the temporary account is not removed at the end of the session. Instead, the user or its network operator may set a lifetime of the account thus obtaining spending controlled over a certain time frame, for example one day. This means that when defining the account the end-user also gets data set in the access network, for example NAS, PLMN, PSTN so that the spending control function can be invoked each time the user initiates a new session. When the lifetime expires the account is removed. In a further embodiment the user gets a warning on SMS, voice, USSD etcetera before expiry, an option to extend the period/add more funds or simply have the session disconnected.

In a second set of embodiments, the spending control function provides spending control for on-line purchases. On-line purchase control is used to support service and content purchases. Note that the packet switched service GPRS is horizontally separated from the service using GPRS as bearer.

According to one embodiment, a method for spending control for a purchase session is described. A purchase is a chargeable instance based on an event. Examples are paying an image downloaded from the internet or paying the lunch in the local restaurant. A purchase session is a number of subsequent purchases within the same spending control limit. An example of a purchase session where the invention can be applied is on-line gaming since the bearer is normally not connected to the content in more modern systems.

In this embodiment the spending control function is invoked when the subscriber connects to the network access server (NAS) 22 or when the user identifies its means of payment to a content provider or merchant for purchasing a product or a service. This identification is done for example with a generic code identifying the charging control system similar to entering a card number and expiry date Network access as such could also be a service.

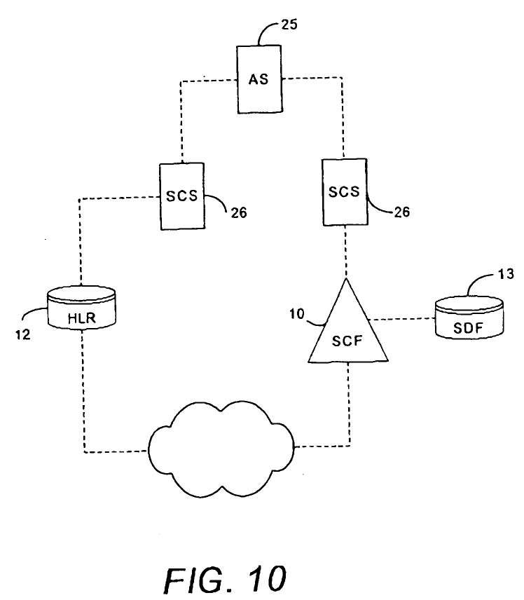

In FIG. 10 an example of a network for accessing the spending control function where the service to be spending controlled resides outside the PLMN is shown. The service is executed in an Application Server (AS) 25 in the service and application layer. The AS communicates with the control layer, i.e. service capability servers (SCS) 26, preferably via standardised APIs. One such standardised API is the Open Services Architecture (OSA)/Parlay standardised by the 3:rd Generation Partnership Program (3GPP). If using OSA, several of its components could be used. Examples are the OSA framework for authentication, HLR 12 and SCF 10 control. An alternative to OSA is to run the service control using XML web services. The interface between the SCS 26 and the spending control function SPCF are protocols such as Parlay, Diameter Accounting/Cost Control Application using methods as RPC or Corba, IN Application Part (INAP) such as CS2, Camel Application Part (CAP) etc.

The spending control function creates an account with a specified amount of money (credit) alternatively the money is transferred as an electronic payment to the charging control system from an electronic wallet that could be stored in the mobile phone or in a smart card attached to the mobile phone/access. At start of a session with a merchant the account identity is submitted and the deductions of events and purchases are done on-line as with ordinary pre-pay purchasing.

If the limit is reached the merchant is not allowed to deduct more money, the end-user gets a notification at disconnection. As an alternative embodiment the notification is depending on access type, e.g. email, SMS, USSD etc. At the end of the session or at a predefined timeout the final charge is output in a CDR indicating that this CDR overrides other CDRs produced in the network. This is done in mediation device or billing system as described in conjunction with previous embodiments. If money was transferred from the subscriber at account creation the money remaining is returned and the account is removed.

In a yet another embodiment, the end-user has the possibility to set the spending control limit at purchase session start. This limit can then either be the final limit or the end-user could be prompted if the limit shall be extended further when the limit is reached.

In an additional embodiment it is possible for the operator or user to, after defining the account limit, set a time based lifetime of the limitation, e.g. one day. This means that when defining the account the user also gets data set in the network access server (NAS) 22, content server 19 or gets a reference to enter when identifying the means of payment, i.e. the account in the charging control system. The account is removed when the lifetime expires.

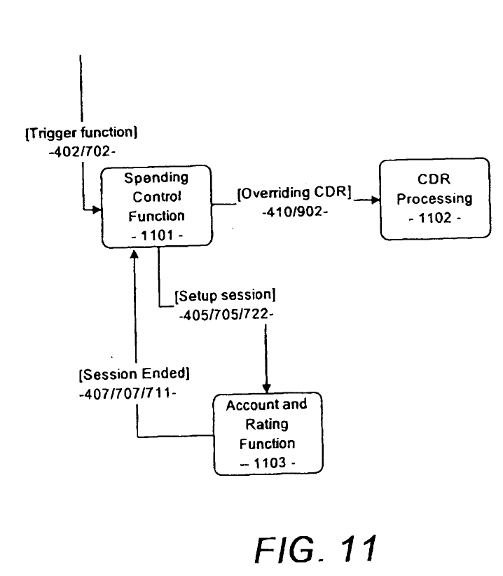

With reference to FIG. 11, the distribution of primary processes/functions involved in the spending control are depicted. The spending control function 1101 SPCF 16 itself is normally processed by the SCP 11 in an IN based solution but is in a preferred embodiment located in the SDP 14. For non-IN services it could likewise be executed by the application server AS 25, the latter for purchase control in particular. The Account and Rating Function ARF 1103 would, especially for session control, normally be handled by the SCP 11 in communication with the SSP/SSF 9. The CDR processing tasks is located to the mediation device 23 or the billing center 24

1. A method for providing spending control to a user in a communications system wherein a request for service(s) payable by said user invokes a spending control function, comprising:
establishing an association between the user and a spending control account for temporary spending control, said spending control account being chargeable for a plurality of different services,
initializing a spending control parameter for said spending control account with a spending control limit,
requesting one or more service(s) to be delivered to the user,
monitoring the cost of the one or more service(s) and indicating when said cost amounts to the spending control limit.

2. A method according to claim 1, wherein the step of establishing an association, includes creating said spending control account.

3. A method according to claim 1, wherein the step of indicating when said cost amounts to the spending control limit includes cutting off the service(s).

4. A method according to claim 1, wherein the step of invoking the spending control function includes that the user indicates that the spending control function should be used.

5. A method according to claim 1, wherein before the step of initializing a spending control parameter, an amount corresponding to the spending control limit is withdrawn from a source account.

6. A method according to claim 5, wherein the source account is an electronic wallet, a handset based prepaid account, or a post-paid subscription.

7. A method according to claim 1, wherein the spending control parameter is initialized with a spending control limit dependent on subscriber or service type.

8. A method according to claim 1, wherein the association between the user and the spending control account is removed after a time interval.

9. A method according to claim 1, wherein usage of said service(s) to be delivered to the user is charged in real time.

10. A method according to claim 1, wherein said limit is set dependent on user/subscriber data.

11. A method according to claim 1, wherein said account is fetched from a pool, or is created at usage, or permanently linked tQ the user/subscriber.

12. A method according to claim 1, further comprising, when said cost amounts to the spending control limit, extending the spending control limit.

13. A computer program comprising program instructions for causing a computer to perform the method of claim 1.

14. A computer program on a carrier and comprising computer executable instructions for causing a computer to perform the method according to claim 1.

15. A computer program according to claim 14, wherein said carrier is a record medium, computer memory, read-only memory or an electrical carrier signal.

16. A data processing system for providing spending control to a user in a communications system comprising computer processing means for processing data, and storage means connected to said computer processing means for storing data on a storage medium, wherein said computer processing means is configured to, in response to a request for service(s) payable by said user, invoke a spending control function which is arranged to establish an association between the user and a spending control account for temporary spending control, said spending control account being chargeable for a plurality of different services, initialize a spending control parameter for said spending control account with a spending control limit, request one or more Service(s) to be delivered to the user, monitor the cost of the one or more service(s) and indicate when said cost amounts to the spending control limit.

17. A data processing system according to claim 16, wherein said function is arranged to create said spending control account at the establishment of said association.

18. A data processing system according to claim 16, wherein said function is arranged to cutting off the service(s) when said cost amounts to the spending control limit.

19. A data processing system according to claim 16, wherein the computer processing means is configured to receive a command from the user indicating that the spending control function shall be used.

20. A data processing system according to claim 16, wherein the spending control function is arranged to, before the spending control parameter (404, 704) is initialized, withdraw an amount corresponding to the spending control limit from a source account.

21. A data processing system according to claim 20, wherein the source account is an electronic wallet, a handset based prepaid account, or a post-paid subscription.

22. A data processing system according to claim 16, wherein the function is arranged to initialize the spending control parameter with a spending control limit dependent on subscriber or service type.

23. A data processing system according to claim 16, wherein the function is arranged to remove the association between the user and the spending control account after a time interval.
